(19) United States
(12) Patent Application Publication
(10) Pub. No.: US 2016/0285877 A1
(43) Pub. Date: Sep. 29, 2016

(54) SYSTEMS AND METHODS FOR ENABLING OUTPUT DEVICE FEATURES

(71) Applicant: Sonifi Solutions, Inc., Sioux Falls, SD (US)

(72) Inventors: Andy Loren Anderson, Sioux Falls, ID (US); Sridhar Guthula, Sioux Falls, SD (US); Derin M. Zerr, Kahului, HI (US); Joel Walter Zdepski, Mountain View, CA (US)

(21) Appl. No.: 15/082,064

(22) Filed: Mar. 28, 2016

Related U.S. Application Data
(60) Provisional application No. 62/138,739, filed on Mar. 26, 2015.
(60) Provisional application No. 62/170,992, filed on Jun. 4, 2015.

(51) Int. Cl. H04L 29/06

(52) U.S. Cl. CPC H04L 63/10; H04L 63/18

(57) ABSTRACT

Methods and systems for enabling a function based on location information for a mobile device are provided. The location information is provided from a sensor device. The sensor device can have a known location, and can provide information identifying the mobile device to a system authority that enables the function. The mobile device can also provide additional identifying information to the system authority. Different communication channels established partially or entirely over different communication networks can be used to deliver the different identifiers.

### CROSS-REFERENCE TO RELATED APPLICATIONS

This application claims the benefit of U.S. Provisional Patent Application Ser. No. 62/138,739, filed Mar. 26, 2015, and U.S. Provisional Patent Application Ser. No. 62/170,992, filed Jun. 4, 2015 the entire disclosures of which are hereby incorporated herein by reference.

### FIELD

Systems and methods for enabling output device features in response to detecting the presence of a mobile device are provided.

### BACKGROUND

Guests of hospitality facilities very often carry mobile devices. These mobile devices, such as smart phones, can be used for a variety of functions. For example, in addition to supporting voice communications, mobile devices are often capable of supporting textual communications, browsing the Internet, and running various apps or applications. Increasingly, mobile devices are also being used as a store of credentials associated with the user, enabling the mobile device to perform other functions, such as a digital wallet function. As a further example, mobile devices are now used to access video services, including but not limited to streaming video services, such as Netflix.

Hospitality facilities, including but not limited to hotels, can offer a variety of amenities to guests. For example, within a guest room, various entertainment devices, such as but not limited to televisions and on demand programming, can be provided. In order to enhance the guest experience, the content that is provided to a guest can be customized. For example, a welcome screen displaying the guest's name can be presented when the guest turns on a television in that guest's room. Further customization, such as the selection of channels available or offered to the guest, is also desirable. However, programming customized features such that they are presented to the intended guest can be a complex and time-consuming process for the hospitality facility, and is also prone to errors, such as when the room assigned to a particular guest is changed for some reason.

Also, safeguards against providing restricted information and programming, including but not limited to safeguards against providing copyrighted materials to unauthorized users, are often required.

In addition to entertainment systems, hospitality facilities often feature other amenities, such as restaurants, bars, exercise rooms, and recreational facilities, such as pools, golf courses, and tennis courts. Although facilities often allow guests to have charges for such amenities added to their room bill, the process for doing so has required manual verification of billing information by facility personnel. Accordingly, such processes have been slow and prone to error.

### SUMMARY

Embodiments of the present disclosure are directed to systems and methods for enabling output device features. Embodiments of the present disclosure further provide technological solutions to establishing multiple factor authentication in the context of an interactive system. A system as disclosed herein can include a sensor device having a known location that is capable of sensing the presence of and identifying mobile devices. The sensor device can provide information identifying a mobile device in the vicinity of the sensor device to a system authority. Alternatively or in addition, the mobile device can provide identifying information to the system authority. In response, the system authority can cause an output device also in the vicinity of the mobile device, or the mobile device itself, to provide or enable selected content. In accordance with further embodiments of the present disclosure, a system as disclosed herein can enable facility related functions and access to amenities.

The sensor device can be provided in the form of a standalone room sensor device, or can be incorporated into another device, such as a television, set top box, remote control unit, video or media player, or the like. The sensor device has a known location and a unique identifier. The identifier associated with the mobile device that is read by the sensor device can be any unique or semi-unique identifier, such as but not limited to a telephone number, Mac address, or other number associated with the mobile device itself, or a loyalty membership account number, subscription accounts identifier, or any other personal identification number associated with the user of the mobile device. The sensor device can communicate with the system authority using a first communication channel established over a first or facility communication network.

The mobile device can also be in communication with the system authority. Accordingly, the mobile device can also send identifying information to the system authority. Such information can be in addition to or in coordination with the information provided by the sensor device to the system authority. Communications between the mobile device and the system authority can be over a second communication channel established over a second communication network. The second communication network can be a network made available by a hospitality facility, such as a guest WiFi network, or can be a communication network that is separate from a network provided by the facility, such as a cellular communication network.

The system authority can be implemented on a server device located at the hospitality facility, and/or at a location remote from the hospitality facility containing the sensor device. The server device can include or have access to information associating the identifier read by the sensor device with reservations, assignments, preferences, permissions, subscriptions, or other information related to content that can be or is presented to the user by the output device. The system authority can also include or have access to information associating an identifier or other information with a particular mobile device that is passed to it from that mobile device. The system authority can be connected to one or more networks directly or through one or more intermediate networks, such as the Internet.

In accordance with at least some embodiments of the present disclosure, the sensor device provides information identifying a mobile device detected by the sensor device as being in the vicinity of the sensor device, and information identifying the sensor device, to the system authority. In accordance with further embodiments of the present disclosure the sensor device delivers a specially provided identifier or other credential obtained from the mobile device to the system authority. Alternatively or in addition, the mobile device can provide a specially provided identifier or other credential to the system authority through a network node other than the sensor device, in addition to a mobile device identifier provided to the system authority by the sensor. Upon receiving this information, the system authority can enable or authorize actions or services. Embodiments of the present disclosure can provide security features that ensure an enabled feature or content is provided only to or in connection with an authorized mobile device. These security features can include multiple factor authentication.

Additional features and advantages of embodiments of the present disclosure will become more readily apparent from the following description, particularly when taken together with the accompanying drawings.

### BRIEF DESCRIPTION OF THE DRAWINGS

FIG. 1 is a block diagram depicting components of a system in accordance with embodiments of the present disclosure;

FIG. 2 is a block diagram depicting components of a sensor device, a server device, and a mobile device in accordance with embodiments of the present disclosure;

and

FIG. 3 is a flowchart depicting aspects of a method in accordance with embodiments of the present disclosure.

### DETAILED DESCRIPTION

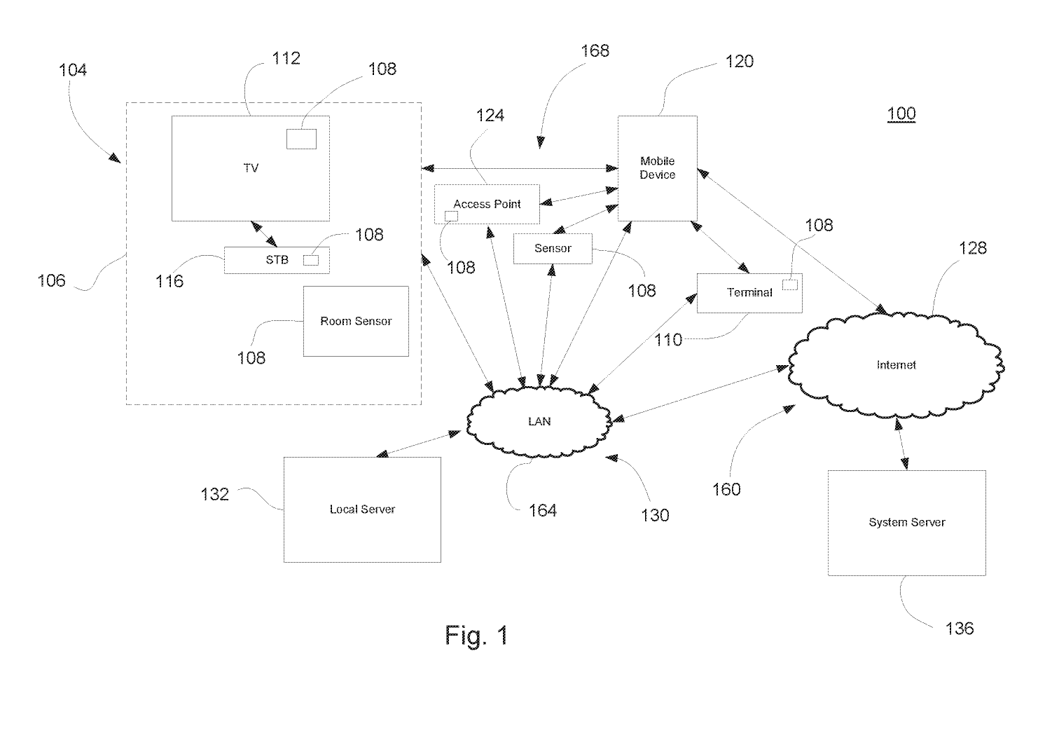

FIG. 1 is a block diagram depicting components of a system 100 in accordance with embodiments of the present disclosure. The system 100 can include a number of components located in a particular area or room of a hospitality facility 104, such as a guest room 106. In particular, a sensor or room sensor device 108 and an output device 112, such as a television, can be located in the room 106. Alternatively or in addition, a set top box 116 can be located in the room 106. As can be appreciated by one of skill in the art after consideration of the present disclosure, a set top box 116, which can include a video or media player, such as a Chromecast device, can provide connectivity, playback, tuning, recording, or other functions. The sensor device 108 can be implemented as a standalone sensor device 108, or it can be provided as part of another device, such as the not limited to a television 112 or a set top box 116. Moreover, multiple sensor devices 108 can be located within a room 106. In such embodiments, each sensor device 108 can be associated with a particular guest room or a specific area or room within a suite.

Alternatively or in addition, sensor devices 108 can be provided that are distributed around a property or hospitality facility 104. For example, sensor devices 108 can be located in public or common areas of a property 104, such as lobbies, lounges, bars, restaurants, recreational areas, exercise rooms, pools, cabanas, tennis courts, golf courses vending machines, or the like. The sensor devices 108 can be associated with fixed locations. Alternatively or in addition, the sensor devices 108 can be associated with particular amenities, whether or not such amenities have a fixed location. For example, a sensor device 108 can be associated with a golf cart or other mobile device. As a further example, sensor devices 108 can be associated with terminals 110, such as point-of-sale terminals, associated with the hospitality facility 104.

The system 100 also includes the mobile device 120. The mobile device 120 can include a smart phone, tablet, lap top or other portable device that is capable of supporting communications between the mobile device 120 and other devices or systems. In addition, the mobile device 120 is associated with one or more unique identifiers. A unique identifier can include a device serial number, telephone number, or other identifier associated with the mobile device 120 itself. Alternatively or in addition, the unique identifier can include a loyalty program membership number, subscription number, personal identification number, or other identifier associated with a user of the mobile device 120. In accordance with still other embodiments of the present disclosure, the unique identifier can include an identifier that is assigned by a system authority, for example implemented as part of a local server 132 or a system server 136.

The mobile device 120 can support communications over one or more communication networks. These networks can include a wide area network 160, such as a cellular, satellite, or other telephony communication network; a local area network 164, such as a Wi-Fi network; or a personal area network or direct connection 168, such as a Bluetooth, near field communication, ZigBee, wireless USB, infrared, or RFID network or connection. As can be appreciated by one of skill in the art after consideration of the present disclosure, such wireless connections can provide connectivity to the public switched telephony network, the Internet, or private networks. A system 100 can also support wireline connections, such as wired Ethernet, HDMI, and USB port connections made to nodes included in a network 160, 164, or 168

The mobile device 120 can communicate over communication networks through connections established between the mobile device 120 and an access point 124, such as but not limited to a wireless access point, for example a Wi-Fi access point provided as part of a hospitality facility guest Internet access (GIA) system, or an access point 124 in the form of a cellular base station, or other communication system component. The access point 124 can connect the mobile device 120 to a larger communication network, such as but not limited to the Internet 128. In accordance with at least some embodiments, a sensor device 108 is operable to deliver limited information from the mobile device 120 to a system authority 132, 136. Such information can include information regarding the mobile device 120 or the user of the mobile device 120.

One or more server devices, such as a local server 132 and/or a system server 136 are also included in the system 100, and can operate alone or cooperatively to provide a system authority function. In general, a local server 132 is located in the vicinity of the room 106, such as within the hotel or other hospitality facility 104 of which the room 106 is a part. A system server 136 is typically at a location remote from the room 106, such as at a central administration location. Moreover, a system server 136 may provide services to a plurality of hospitality facilities. In general, a server device 132, 136 can communicate with components within a room 104 via the Internet 128, or other network 130, such as a private network, a local area network, and/or dedicated connections. The services provided can include television programming, both broadcast and on demand, subscription services, and programming and features associated with a particular hospitality facility. In addition, the particular content available can be determined, at least in part, based on an identification of the mobile device 120 and/or the associated user as discussed in greater detail elsewhere herein. For example, the channel line-up, programs, movies, or games available to a user of a mobile device 120 can be determined based on the identification of the mobile device 120, and of particular subscriptions or entitlements associated with the mobile device 120.

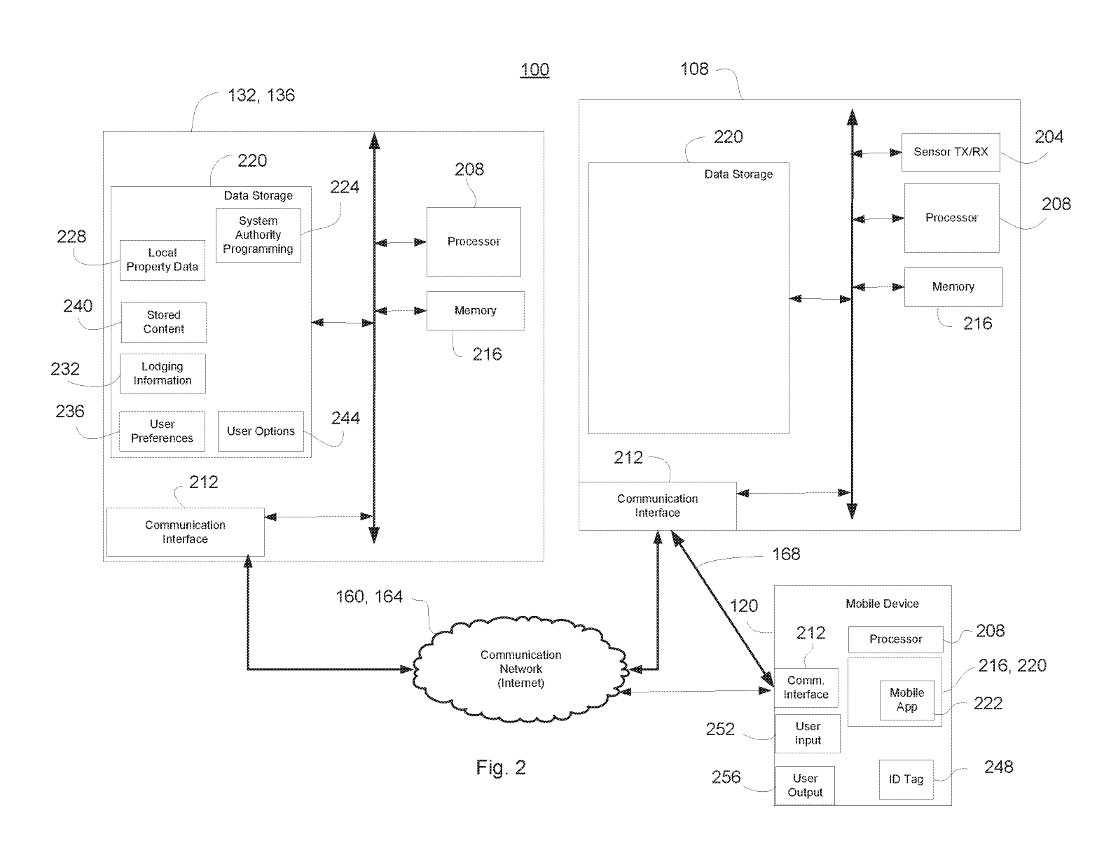

FIG. 2 is a block diagram depicting components of a sensor device and a server device in accordance with embodiments of the present disclosure. In general, the sensor device 108 includes a sensor transmitter/receiver 204 connected to a processor 208. The sensor transmitter/receiver 204 operates to receive an identification signal from a mobile device 120. The received identification signal can be a signal that is actively generated by the mobile device 120, or it can be a signal that is generated or modified in response to the receipt of an interrogation signal sent by the sensor device 108. Where the signal is actively generated by the mobile device 120, it can be generated by an app or application running on the mobile device 120 that is aware of and that is capable of communications with a system authority 132, 136. Examples of a sensor transmitter/receiver 204 include, but are not limited to a near field communications (NFC) device, a Bluetooth communications device, an RFID device, a microphone, a camera, or the like. The identification signal is then translated and/or formatted by an application running on the processor 208, and is sent to a server device 132, 136 over a network or direct connection via a communication interface 212. In accordance with further embodiments of the present disclosure, the communication interface 212 can obtain an identification signal from a mobile device 120, instead of or in addition to a sensor receiver/transmitter 204. As examples, the application may be implemented as firmware or software stored in memory 216 and/or data storage 220, associated with the sensor device 108. Where the sensor device 108 is associated with another device, such as an output device 112 or a set top box 116, other devices and/or applications can be included, as appropriate to the other functions performed by the device 112 or 116.

The server device 132, 136 generally includes a processor 208, memory 216, data storage 220, and a communication interface 212. The server device 132, 136 operates as a system authority, and controls services that are enabled in response to detecting the presence of an identified mobile device 120. Accordingly, the server device 132, 136 can include system authority programming 224 executed by the processor 208. For example, as discussed in greater detail elsewhere herein, the server device 132, 136 can enable particular programming options that are selected based on the determined location of the mobile device 120 and on an identification of the mobile device 120. The programming options can be a function of entertainment channels, communication options, or other system parameters determined by the property with which a room 104 is associated, and such data can be stored as local property data 228. The local property data 228 can include information regarding the locations of sensor devices 108. In addition, the identification of the mobile device 120 in the enablement of features can require the association of the mobile device 120 with an assigned room 104. Accordingly, the system authority 132, 136 can store or have access to lodging information 232. User specific selections can be stored as user preferences 236. In addition, the server device 132, 136 can store or have access to stored content 240, which can be content associated with a particular hospitality facility, subscription service, the mobile device 120, or an individual user. In particular communication and entertainment options available or presented to a user can be stored as user options data 244.

The mobile device 120 can comprise a smart phone, or other mobile device having communication capabilities and the ability to carry a unique identifier. In an exemplary embodiment, the mobile device 120 includes a processor 208, memory 216 and/or data storage 220. A mobile app or application 222 can be stored in the memory 216 and/or data storage 220. The mobile app 222 functions to provide a unique identifier to the system authority application or programming 224 running on a local 132 or system 136 server. The mobile device 120 also includes a communication interface 212. In a typical embodiment, the communication interface 212 of a mobile device 120 may comprise a set of different communication interfaces 212 that are capable of communications over different networks or communication systems. For example, a communication interface 212 can include a cellular telephony communication interface, a satellite telephony communication interface, a Wi-Fi interface, a Bluetooth interface, a near field communications interface, an infrared interface, etc. A mobile device 120 can also include an identification tag 248. The identification tag 248 can operate using any of a number of available technologies. For example, the identification tag 248 can be in the form of an RFID tag, a barcode, a speaker, a configurable display, or any other component or function capable of providing an identification signal, alone or in response to an external stimulus. Therefore, in accordance with at least some embodiments of the present disclosure, a communication from an identification tag to a sensor device 204 is made via a direct connection, rather than through a communication network. A user input 252 and a user output 256 are also generally included. As can be appreciated by one of skill in the art after consideration of the present disclosure, various components of the mobile device 120 (and other system 100 components) can perform multiple functions. For example, a communication interface 212 of a mobile device 120 can perform the functions of an identification tag 248. Moreover, various components generally operate in combination with one another. For example, a communication interface 212 can perform an identification tag 248 function in combination with the execution of a mobile app 222 and in particular with an identification function of the mobile app 222 performed in connection with the system authority programming 224.

In accordance with embodiments of the present disclosure, the sensor device 108 operates to provide information regarding the location of a mobile device 120. For example, where the communication network or link used to establish a communication channel between the sensor device 108 and the mobile device 120 is by its nature limited in range, the existence of such a communication channel, in combination with a known location of the sensor device 108, provides information regarding the location of the mobile device 120. For example, a mobile device 120 can be determined to be in a particular room if an identification signal is being communicated from that mobile device 120 to a sensor device 108 in that room. Alternatively or in addition, identifying information regarding a mobile device 120 that is obtained from multiple sensor devices 108 simultaneously or in series can be used to determine the location of the mobile device 120.

A mobile device 120 can also provide location, identifying, and or other information to a system authority 132, 136 separately from and in addition to information provided by a sensor device 108. In accordance with at least some embodiments of the present disclosure, the system authority 132, 136 may require that such additional information be received at or about the same time as location information is received from a sensor device 108 having a known location. The additional information can include subscription information or other credentials, and/or location information, such as information obtained from a GPS receiver provided as part of the mobile device 120, location information provided by a cellular system, or other location information obtained separately from the location information provided by the sensor device 108. Accordingly, embodiments of the present disclosure provide a system that enables multiple factor authentication using multiple communication links to be performed.

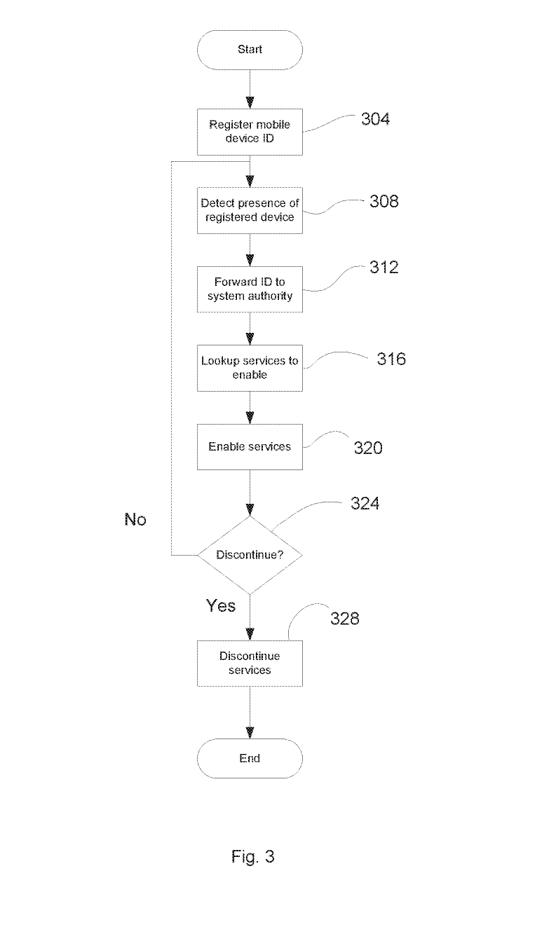

FIG. 3 is a flowchart depicting aspects of a method for enabling output device features in accordance with embodiments of the present disclosure. Initially, at step 304, a mobile device 120 identifier is registered with a system authority, implemented by a local 132 and/or system 136 server. For example, but without limitation, a mobile device 120 identifier can be registered with a system authority 132, 136 when a guest associated with the mobile device 120 checks into a hospitality facility. As other examples, a mobile device 120 identifier can be registered with a system authority 132, 136 associated with a hospitality provider loyalty program, an entertainment system subscription service, or the like.

At step 308, a sensor device 108 having a known location detects the presence of an identifier of a registered mobile device 120. For example, a sensor device 108 provided as a standalone device, as part of a television or other output device 112, or as part of a set top box 116, detects the mobile device 120, and in particular the unique identifier associated with the mobile device 120, in the proximity of the sensor device 108. One or more communication and/or sensor technologies can be utilized for detecting the presence of the mobile device 120. Examples of such technologies include, but are not limited to, near field communications (NFC), radiofrequency identification (RFID), infrared (IR) communications, Bluetooth (BT) communications, and the like. The sensor device 108 then forwards the identifier associated with the mobile device 120 to the system authority 132, 136 (step 312). For example, where both a local server 132 and a system server 136 provide some or all of the system authority functions, the unique identifier can be sent over a local or facility network to the local server 132, and from there to the system server 136, for example over a corporate intranet, the public switched telephony network (PSTN), or a wide area network, such as the Internet.

Upon receipt of the unique identifier, the system authority can perform a lookup operation, to determine services to be enabled (step 316). For example, the set of communication channels, entertainment channels or other entertainment options available through the output device 112 in a room 104 can be constrained, enhanced, or otherwise modified from a generic set of options based on preferences, subscriptions, or entitlements associated with the user of the mobile device 120. In addition to controlling the set of communication and entertainment options, the system authority can cause the output device 112 to turn on upon detection of the mobile device 120 in the vicinity of the output device 112. For example, a guest that is enrolled in a hospitality facility loyalty program, and that has entered and stored preference data with respect to entertainment options, can select as a user preference that the television 112 be automatically turned on and tuned to a particular channel when the guest enters the room 104. Other functionality is also possible. For example, lights in the room can be turned on, and the like. In at least some embodiments, such functions can be enabled solely from the provision of the identifying information from the sensor device 108. Alternatively or in addition, some or all of the functions can be enabled in response to the receipt of the identifying information from the sensor device 108, in combination with a request for a function received at the system authority 132, 136 from an output device 112 or the mobile device 120. The identifying information received from the sensor device 108 can include the location of the sensor device 108, or an identification of the sensor device 108 that can be used to look up the location of the sensor device 108 from local property data 228. In accordance with still other embodiments of the present disclosure, a system authority 132, 136 may require that location, credential or other information be received from the mobile device 120, in addition to receiving identifying information from the sensor device 108. At step 320, the services authorized or determined through the lookup operation are enabled. In accordance with at least some embodiments of the present disclosure, access to features can be enabled in stages. For example, an output device 112 such as a television can be powered on when a sensor device 108 located in a hallway detects that a mobile device 120 associated with a guest is approaching the guest's room. After the output device 112 is powered on, the system authority 132, 136 can access user preference information 244 associated with the guest to configure an available channel line-up according to the preferences and/or credentials associated with the guest.

At step 324, a determination can be made as to whether the delivery of content should be discontinued. For example, in accordance with at least some embodiments, the system authority can require that continuous, periodic, or intermittent location information be provided to confirm that the content is being delivered to an authorized location, or that the authorized user, as represented by the mobile device 120, is at the location to which the content is being delivered. If such location information is absent, or if received location information indicates that the mobile device 120 has moved to an unauthorized location, the delivery of content can be suspended or terminated (step 328). For instance, the delivery of content can be discontinued if the sensor device 108 in a room 106, another sensor device 108, and/or the mobile device 120 indicates to the system authority 132, 136 that the mobile device 120 is no longer in an area associated with the authorized delivery of content. As another example, a user of the mobile device 120 can send a signal, through the mobile device, a control associated with an output device 112, or otherwise, discontinuing the delivery of content. As yet another example, the expiration of a subscription, or a determination that a guest associated with the mobile device 120 has checked out of the room associated with the original request for content or services, can result in suspending or terminating the provision of the content or service. After discontinuing the delivery of the content or service, the process can end.

In accordance with further embodiments of the present disclosure, the system authority 132, 136 can require credential, location, or credential and location information from the mobile device 120, in addition to the identifying or location information provided by the sensor device 108. For example, subscription, password, encryption key, payment, or other information can be provided from the mobile device 120 in order to access particular content. Alternatively or in addition, location information from the mobile device 120 can be required by the system authority to confirm that content is or will be delivered appropriately.

In accordance with still other embodiments of the present disclosure, content is delivered to the mobile device 120, in addition or as an alternative to being delivered to an output device 112. For example, a copy of content being delivered to the output device 112 in a room can also be delivered to the mobile device. As another example, content can be delivered to the mobile device 120 only; or content can be delivered to the output device 112 while supplemental content, such as a channel guide, web based explanatory material, or other information is delivered to the mobile device 120.

Embodiments of the present disclosure can also be used to provide services and functions in connection with sensor devices 108 that do not have a fixed location, but that are associated with a specific amenity. For instance, a sensor device 108 associated with a golf cart can detect that a mobile device 120 is nearby. In response, the system authority 132, 136 can send a query to the mobile device 120, asking the user whether use of the golf cart is desired. If so, the user can respond affirmatively, and can provide or enable the mobile device 120 to send payment credentials or an authorization to the system authority 132, 136, which can then enable operation of the cart. The system authority 132, 136 can require that the mobile device provide location information, continuously, periodiclaly, or intermittently, and can cause the cart to shut down if the cart is taken offi of the hospitality facility property, or if the sensor device 108 indicates that the mobile device 120 has been separated from the cart. Accordingly, a location related signal from both the sensor device 108 and the mobile device 120 can be required in order to enable operation of the cart.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A system for enabling output device features, comprising:
a mobile device, wherein a first identifier is associated with the mobile device;
a sensor device, wherein the sensor device has a known location, and wherein the sensor device is operable to read the first identifier associated with the mobile device;
a system authority, wherein the system authority is configured to receive the first identifier from the sensor device, and in response is configured to enable at least a first function.

2. The system of claim 1, further comprising:
a first network, wherein the mobile device is in communication with the sensor device over the first network.

3. The system of claim 2, further comprising:
a second network, wherein the mobile device is in communication with the system authority over the second network.

4. The system of claim 3, wherein a second identifier is associated with the mobile device, and wherein the second identifier is provided to the system authority over the second network.

5. The system of claim 4, further comprising:
an output device, wherein the first function is outputting content through the output device.

6. The system of claim 4, wherein the first function is outputting content through the mobile device.

7. The system of claim 6, wherein the content is provided to the mobile device over the second network.

8. The system of claim 4, wherein the mobile device includes a processor, memory, and an app stored in the memory, wherein the app is executed by the processor, and wherein the app generates one of the first identifier and a second identifier from a credential stored in the mobile device and from a sensor identifier obtained from the sensor device.

9. The system of claim 8, wherein the first function is a playback function.

10. The system of claim 1, further comprising:
a room output device, wherein the at least a first function is enabling operation of the room output device.

11. The system of claim 10,wherein enabling the operation of the room output device includes presenting a selected information channel using the room output device.

12. The system of claim 11, wherein the selected information channel is selected based on information associated with the mobile device.

13. The system of claim 12, wherein the system authority is further operable to receive stored information regarding the mobile device.

14. The system of claim 13, wherein the stored information regarding the mobile device includes information associating the mobile device with the known location of the room sensor device.

15. A method for enabling functions, comprising:
providing a sensor;
providing a first identifier from a mobile device to the sensor device using a first communication channel;
providing information identifying the sensor device and the first identifier from the sensor device to a system authority;
in response to the system authority receiving the information identifying the sensor device and the first identifier, the system authority enabling a first function.

16. The method of claim 15, further comprising:
providing a second identifier from the mobile device to the system authority using a second communication channel.

17. The method of claim 16, further comprising:
delivering an interrogation signal from the sensor device to the mobile device using the first communication channel;
generating by the mobile device the second identifier using the interrogation signal.

18. The method of claim 17, wherein the first function is delivering content to the mobile device.

19. The method of claim 18, further comprising:
receiving a signal from the sensor device indicating that the mobile device has left a vicinity of the sensor device;
in response to receiving the signal indicating the mobile device has left a vicinity of the sensor device, the system authority discontinuing delivering content to the mobile device.

20. A system, comprising:
a first communication network;
a second communication network;
a system authority, wherein the system authority is connected to the first and second networks;
a sensor device, wherein the sensor device is in communication with the system authority through a first communication channel established over the first communication network;
a mobile device, wherein the mobile device is in communication with the system authority through a second communication channel established over the second communication network, wherein the mobile device is in communication with the sensor device over a third communication channel, wherein the sensor device is configured to provide a first identifier related to the mobile device to the system authority over the first communication channel, wherein the mobile device is configured to provide a second identifier to the system authority over the second communication channel, and wherein in response to receiving the first and second identifiers the system authority is configured to enable a first function.
